(19) United States
(12) Patent Application Publication
(10) Pub. No.: US 2004/0208436 A1
(43) Pub. Date: Oct. 21, 2004

(54) Forming optical signals having soliton pulses with certain spectral band characteristics

(75) Inventors: Farhad Hakimi, Watertown, MA (US); Hosain Hakimi, Watertown, MA (US)

Correspondence Address: WILMER CUTLER PICKERING HALE AND DORR LLP, 60 STATE STREET, BOSTON, MA, 02109, US

(73) Assignee: TeraPhase Technologies, Inc., Waltham, MA

(21) Appl. No.: 10/138,717

(22) Filed: May 3, 2002

Related U.S. Application Data
(63) Continuation-in-part of application No. 10/052,868, filed on Jan. 16, 2002, now abandoned.
(63) Continuation-in-part of application No. 10/053,478, filed on Jan. 16, 2002, now abandoned.
(63) Continuation-in-part of application No. 10/050,635, filed on Jan. 16, 2002, now abandoned.
(63) Continuation-in-part of application No. 10/050,751, filed on Jan. 16, 2002, now abandoned.
(63) Continuation-in-part of application No. 10/050,641, filed on Jan. 16, 2002, now abandoned.
(63) Continuation-in-part of application No. 10/050,749, filed on Jan. 16, 2002, now abandoned.
(60) Provisional application No. 60/354,721, filed on Feb. 5, 2002.
(60) Provisional application No. 60/356,072, filed on Feb. 11, 2002.

(51) Int. Cl. G02B 6/26; G02B 6/293; H04B 10/00; H04J 14/02

(52) U.S. Cl. 385/27; 385/24; 398/192; 398/79

(57) ABSTRACT

In optical signal transmission, an input optical signal is received that has double side band (DSB) spectral characteristics. The input optical signal is optically filtered to produce an output optical signal having single side band (SSB) spectral characteristics. The output optical signal is caused to include a soliton pulse. In optical signal transmission, a modulated RZ optical signal is formed from an input optical signal. The modulated RZ optical signal has single side band (SSB) spectral characteristics. A data modulated optical signal is formed from the modulated RZ optical signal. The data modulated optical signal includes a soliton optical signal that has SSB spectral characteristics and that includes a soliton pulse. The peak power and the mid-amplitude width of the soliton pulse are linked by a relationship that depends on the characteristics of an optical medium in which the soliton pulse travels.

### CROSS-REFERENCE TO RELATED APPLICATIONS

This application claims the benefit of U.S. Provisional Application No. 60/354,721, entitled “SSB SOLITON AND DISPERSION MANAGED SOLITON TRANSMISSION” filed on Feb. 5, 2002, which is incorporated herein by reference in its entirety.

This application claims the benefit of U.S. Provisional Application No. 60/356,072, entitled “A FIBER OPTIC AUTO WAVELENGTH TRACKING FILTER FOR OPTICAL REGENERATORS AND RECEIVERS” filed on Feb. 11, 2002, which is incorporated herein by reference in its entirety.

This application is a continuation-in-part of U.S. patent application Ser. No. 10/052,868, filed Jan. 16, 2002; U.S. patent application Ser. No. 10/053,478, filed Jan. 16, 2002; U.S. patent application Ser. No. 10/050,635, filed Jan. 16, 2002; U.S. patent application Ser. No. 10/050,751, filed Jan. 16, 2002; U.S. patent application Ser. No. 10/050,641, filed Jan. 16, 2002; and U.S. patent application Ser. No. 10/050,749, filed Jan. 16, 2002, all of which are incorporated herein by reference in their entirety.

### BACKGROUND OF THE INVENTION

1. Field of the Invention

This invention relates to forming optical signals having soliton pulses with certain spectral band characteristics.

2. Discussion of Related Art

Transmission of data over long distances, especially transoceanic telephone transmission, is increasingly effected optically using optical fibers. This has significant advantages compared to electrical transmission; in particular losses are low and there is less signal distortion. In such telecommunication systems, in particular for undersea telecommunications, there is a constant need for higher bit rates without degrading signal quality while remaining within reasonable cost limits.

The data transmitted by optical communication systems is in binary form, i.e., the information is represented by “0” bits and “1” bits. The shape of the signals transmitted has a decisive effect on the performance of the transmission system, losses and noise depending on the shape of the signals.

Binary digital signals have been transmitted in the NRZ format, i.e., “0” usually being the low level and “1” the high level. For successive “1” the signal remains at the high level and does not return to the “0” level or low level (hence the name of the format: NRZ stands for “no return to zero”).

A soliton format has been proposed to enhance communication performance. The shape of each soliton pulse as a function of time is the inverse of the square of a hyperbolic cosine. The peak power and the mid-amplitude width of the soliton pulse are linked by a relationship that depends on the characteristics of the fiber, namely the Kerr index n₂ and the dispersion D. The index n₂ is the non-linear part of the refractive index, i.e., the part which depends on the power of the optical signal. This relationship between the peak power and the half-amplitude width is such that the effects of dispersion and of non-linearity cancel each other out. As a result, the pulse's shape does not spread out as the pulse propagates, despite the inevitable chromatic dispersion of optical fibers.

In particular, an optical soliton pulse retains its shape by balancing second order chromatic dispersion and non-linear self-phase-modulation (SPM) in the anomalous dispersion region of fiber.

The further a soliton pulse travels along fiber, the more the soliton pulse is affected by fiber dispersion slope, which is also known as third order dispersion (TOD). The dispersion slope adversely affects the aforementioned balance and causes the soliton pulse to spread in an asymmetric fashion. Consequently, a soliton pulse cannot retain its shape in the presence of dispersion slope for long. Thus, the benefits of soliton format transmission have largely evaded long haul optical communication networks.

Soliton pulses also suffer from self-frequency shift and Gordon-Haus time jitter. Self-frequency shift would pose a cross-talk problem in long haul dense Wavelength Division Multiplexing (WDM) systems, as the center frequency of the pulse no longer adheres to its original ITU grid allocation. Furthermore, the jitter inherent to soliton pulse propagation (which is caused by Amplified Spontaneous Emission (ASE) noise of the in-line amplifiers) would impose a challenge on clock recovery circuits of both long-haul Time Division Multiplexing (TDM) and WDM systems.

Soliton pulse self-frequency shifts and jitters have been reduced by inserting sliding filters. By placing sliding filters in strategic locations along the transmission link, highly stable long-haul soliton pulse transmission has been reported in laboratory experiments. However, placement of the filters in proper locations in real embedded systems and links may not be practical and may increase cost and complexity in the overall system.

With respect to dispersion managed (DM) soliton transmission, it has been recognized that instead of relying on a local balance, as traditionally has been the case for soliton pulses, a lumped balance between dispersion and the non-linearity of the entire link could be relied upon. In DM soliton pulse transmission, Dispersion Compensation Fibers (DCF) are inserted to compensate periodically for the dispersion of the link. In DM soliton pulse schemes, pulses are allowed to spread by local dispersion for most of the travel time, which necessitates a considerably higher average input launch power of the soliton pulse channels than is used for a regular soliton pulse. This is due to a requirement of generating the balancing SPM. Increased channel power is one of the major drawbacks of the DM soliton pulse scheme, especially when a WDM link is concerned, as excess power can cause high cross talks among different channels. The DM soliton pulse scheme, however, has alleviated some of the problems associated with soliton pulse transmission, namely, reduced frequency shifting and less time jitters.

In the soliton format, the “1”s are represented as pulses, generally positive (bright soliton), and the “0”s are represented at the low level. Between two successive “1”s, i.e. between two soliton pulses, the signal returns to the low level consistent with an RZ format (RZ stands for “returning to zero”).

DM soliton pulse transmission still falls short of addressing dispersion slope which ultimately puts a fundamental limit on any long-haul soliton pulse transmission. In addition, interactions among soliton pulses of the same channel (TDM) or different channels (WDM) impose a serious challenge on increasing the data rate of soliton channels beyond 10 or 40 Gb/s per channel.

### SUMMARY OF THE INVENTION

The invention provides apparatus and methods for forming optical signals having soliton pulses with certain spectral band characteristics.

According to one aspect of the invention, in optical signal transmission, an input optical signal is received that has double side band (DSB) spectral characteristics. The input optical signal is optically filtered to produce an output optical signal having single side band (SSB) spectral characteristics. The output optical signal is caused to include a soliton pulse.

According to another aspect of the invention, in optical signal transmission, a modulated RZ optical signal is formed from an input optical signal. The modulated RZ optical signal has single side band (SSB) spectral characteristics. A data modulated optical signal is formed from the modulated RZ optical signal. The data modulated optical signal includes a soliton optical signal that has SSB spectral characteristics and that includes a soliton pulse.

The peak power and the mid-amplitude width of the soliton pulse are linked by a relationship that depends on the characteristics of an optical medium in which the soliton pulse travels.

Other features will become apparent from the following description, including the drawings, and from the claims.

### BRIEF DESCRIPTION OF THE DRAWINGS

FIGS. 1a-1b are diagrams of Double Side Band communication spectrums;

FIG. 2 is a block diagram of an example of a Single Side Band soliton transmission system according to a certain embodiment of the invention;

FIGS. 2a-2c are spectral diagrams of examples of signals supplied to or produced by a Single Side Band soliton transmission system according to certain embodiments of the invention;

FIGS. 3a-3f are block diagrams of examples of Single Side Band soliton transmission systems according to certain embodiments of the invention;

FIGS. 4a-4b are block diagrams of examples of RZ soliton transmission systems according to certain embodiments of the invention; and

FIG. 5 is a block diagram of an example of a WDM soliton transmission system according to a certain embodiment of the invention.

### DETAILED DESCRIPTION

The present invention provides improved systems and methods for transmitting optical signals. Among other things, preferred embodiments address improvements in the formation and use of soliton pulses, particularly in regard to spectral band characteristics. Certain embodiments improve soliton transmission through the use of IIR (infinite impulse response) and/or FIR (finite impulse response) filtration techniques. Other embodiments improve soliton transmission through the use of enhanced techniques in connection with RZ modulation.

Soliton format transmission, by definition, is conducted in an RZ pulse format. One way to generate streams of individual pulses (that may, for example, become individual soliton pulses) is by using mode-locked laser sources or an external modulator that carves individual pulses out of a continuous wave (CW) laser source.

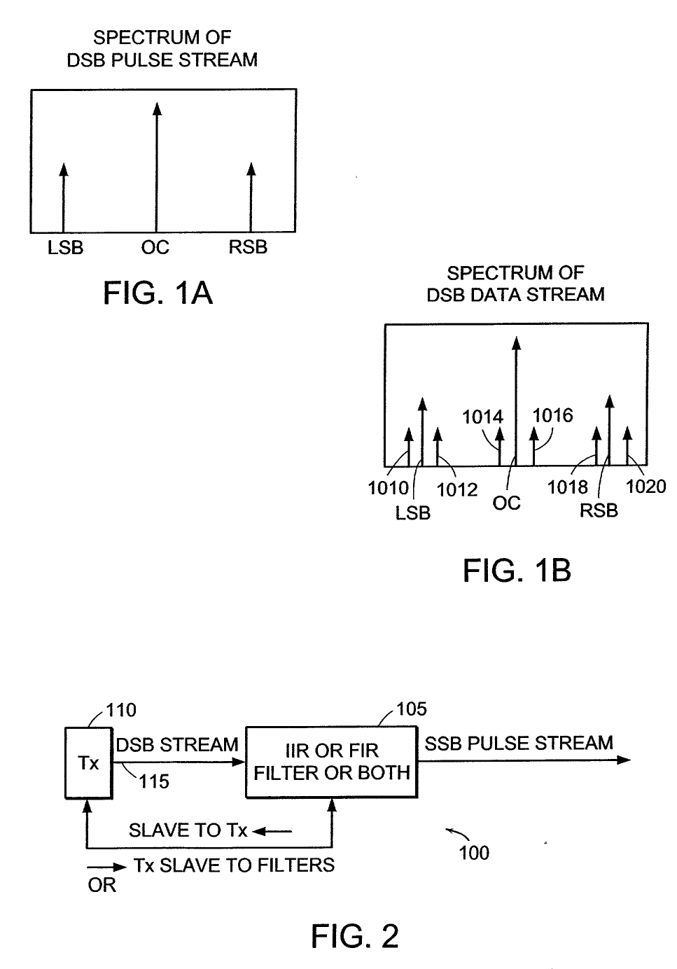

A conventional generation of a pulse stream (such as a soliton pulse stream) produces a Double Side Band (DSB) spectrum. As shown in FIG. 1a, an optical carrier OC with two side bands RSB and LSB is generated. Then, data is modulated on the OC and side bands shown in FIG. 1a to generate data side bands 1014, 1016 around the carrier OC, data side bands 1010, 1012 around band LSB, and data side bands 1018, 1020 around band RSB, as shown in FIG. 1b. Each pulse in the stream is subject to dispersion according to the relation Δτ=(D*L*Δλ), where Δτ is temporal spread, D is the fiber dispersion in ps/Km.nm and L is the fiber length in Km and Δλ is the spectral width in nm. In order for each pulse in the stream to form a soliton pulse, sufficient SPM is generated to counteract the dispersion.

In certain embodiments of the invention, pulse streams (e.g., soliton pulse streams) are created that spectrally are Single Side Band (SSB) in nature. For example, by filtering out one of the side bands in the spectrum of the stream, the effective dispersive effect on the stream is immediately reduced by factor of approximately 4. (With reference to a section below entitled “Soliton Creation”, since the filtering causes the pulse duration to increase, the effect of the dispersion is reduced as the square of the pulse duration increase.) This in turn translates to less power required to generate SPM to counterbalance the dispersion, in fact by 10*log(4)=6 dB. In addition, removing the unwanted redundant side bands further reduces the overall power requirement for the stream of pulses (e.g., soliton pulses). Accordingly, the magnitude of power- and intensity-related side effects, including nonlinear effects and crosstalk, are correspondingly reduced.

When the soliton pulse stream has an SSB spectrum, the Gordon-Haus jitter and self-frequency shift of the soliton pulses in the stream are also greatly reduced, as a natural consequence of having spectrally narrower soliton pulses, which are less prone to jitters and frequency shifts.

Another benefit of the SSB pulse stream is a reduction in cross talk among different channels (in WDM) or among pulses of the same channel (in TDM). The lower power requirement of the SSB soliton pulse stream improves intensity dependent characteristics of the link, including self phase modulation (SPM), cross phase modulation (XPM), four wave mixing (FWM), and polarization mode dispersion (PMD). The SSB nature also allows for Raman pump technology to be used efficiently since energy is not being expended on the filtered out sideband.

### IIR and/or FIR Filtration Techniques

In certain embodiments, IIR and/or FIR filtration techniques are used to filter out a side band from an existing DSB pulse stream optical signal, and known amplification techniques are used to control the intensity to cause the filtered results to be transmitted as an SSB soliton pulse stream. Examples of IIR and/or FIR filtration techniques are disclosed in one or more of the following patent applications, each of which is hereby incorporated herein by reference in its entirety: U.S. patent application Ser. No. 10/052,868, filed Jan. 16, 2002; U.S. patent application Ser. No. 10/053,478, filed Jan. 16, 2002; U.S. patent application Ser. No. 10/050,635, filed Jan. 16, 2002; U.S. patent application Ser. No. 10/050,751, filed Jan. 16, 2002; U.S. patent application Ser. No. 10/050,641, filed Jan. 16, 2002; U.S. patent application Ser. No. 10/050,749, filed Jan. 16, 2002; and U.S. patent application entitled “FILTERING NOISE IN OPTICAL SIGNAL TRANSMISSION, which is being filed simultaneously herewith.

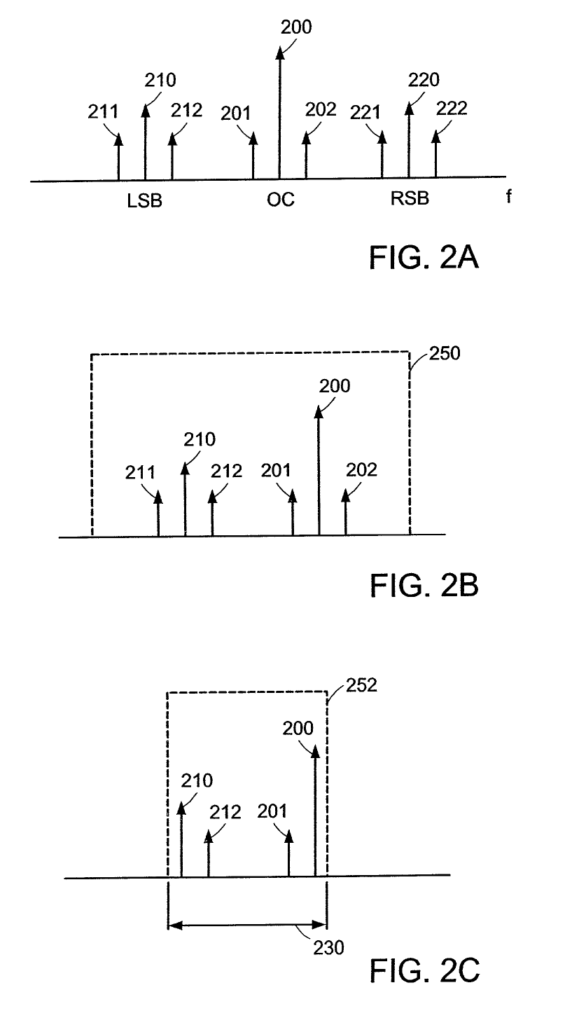

Referring to FIG. 2, IIR and/or FIR filters are used to optically filter a side band out of a DSB pulse stream optical signal from a transmitter. System 100 may include a tunable IIR and/or FIR filter block 105 in optical communication with transmitter (Tx) 110 via optical link 115. In some embodiments, filter block 105 acts as a slave to Tx 110, e.g., such that the filter block's center frequency is adjusted in response to a potentially wandering center frequency at Tx 110. In other embodiments, Tx 110 may act as a slave to filter block 105, e.g., such that Tx 110 adjusts its center frequency in response to control signals from filter block 105. Tx 110 and/or filter block 105 may have some or all of the characteristics described in one or more of the patent applications incorporated by reference above. As described in more detail below, filter block 105 reshapes the spectrum of the pulse stream received from Tx 110 by removing side-band spectral components. The configuration of Tx 110 may be responsive to filter block 105. The configuration of filter block 105 may be responsive to Tx 110. For example, the detected energy, power, or OC of the DSB stream or the SSB stream may be used to adjust the output intensity or other characteristics of Tx 110.

FIG. 2a illustrates the frequency spectrum of signals emitted by a conventional optical transmitter, such as Tx 110, which spectrum and transmitter are described in one or more of the patent applications incorporated by reference above.

In one embodiment, filter block 105 removes one of the side band components; that is, either the left side band (LSB) together with its data side bands 211, 212, or the right side band (RSB) together with its data side bands 221, 222. FIG. 2b illustrates an example in which a filter depicted by box 250 is implemented by filter block 105 and results in the removal of the right side band (RSB) together with its data side bands 221, 222. Filtering block 105 can also be tuned to reduce or attenuate one or more of components 200, 201, 202 to correspond to (e.g., to equalize their powers with respect to) the power of LSBs 210, 211, 212 respectively (known as a symmetric shape spectrum). In other embodiments, filter block 105 removes additional side band spectral components. FIG. 2c, for example, illustrates that a narrower filter depicted by box 252 and implemented by filter block 105 results in the additional removal of side band spectral components 202, 211. As described above, filter block 105 can be tuned to reduce the power of components 200, 201 to match or otherwise correspond to LSB power components 210, 212 respectively (the symmetric shape spectrum).

Filter block 105 may include technology from one or more IIR and/or FIR filters as disclosed in one or more of the patent applications incorporated by reference above, such as a high finesse Fabry perot etalon, an electronically tunable liquid crystal Fabry-Perot filter, Fiber Brag Grating (FBG), a Michelson interferometer, an electronically tunable liquid crystal FIR filter, and/or a Mach-Zehnder type interferometer.

### RZ Modulation

In certain embodiments, RZ modulation is used in the creation of an SSB pulse stream (e.g., soliton pulse stream). In certain embodiments, RZ modulation is used to produce an SSB optical signal which is then modulated with data to produce a data modulated SSB optical signal. Pertinent principles are described in “Design and application of discrete-time fractional Hilbert transformer,” by C. C. Tseng and S. C. Pei, IEEE Trans. On Circuits and Systems-II: Analog and Digital Signal Processing, Vol.47, No.12, pp.1529-1533, December 2000.

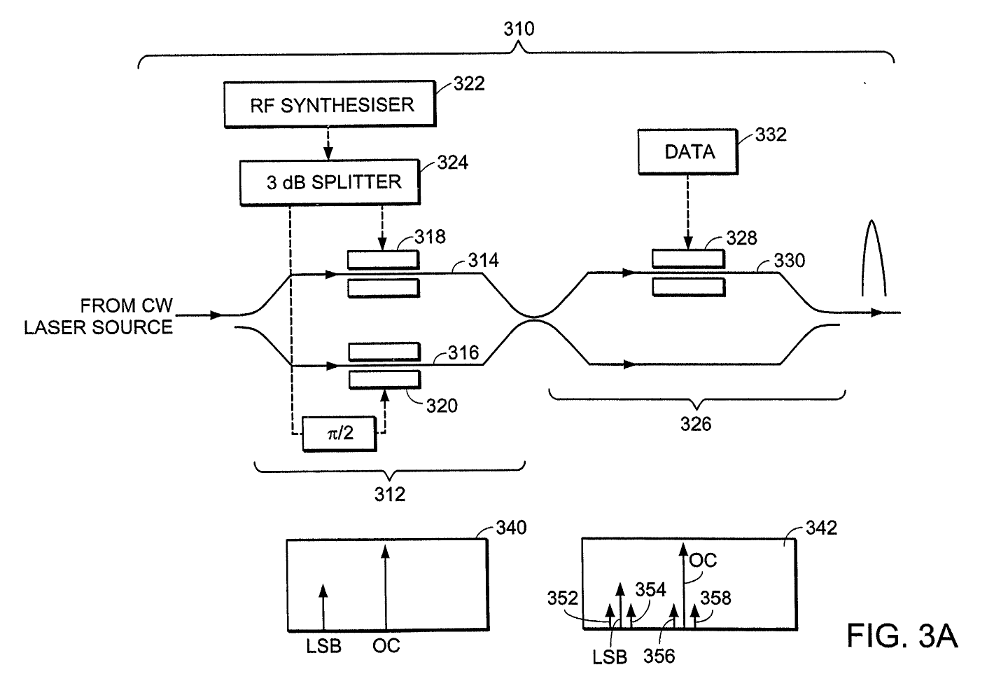

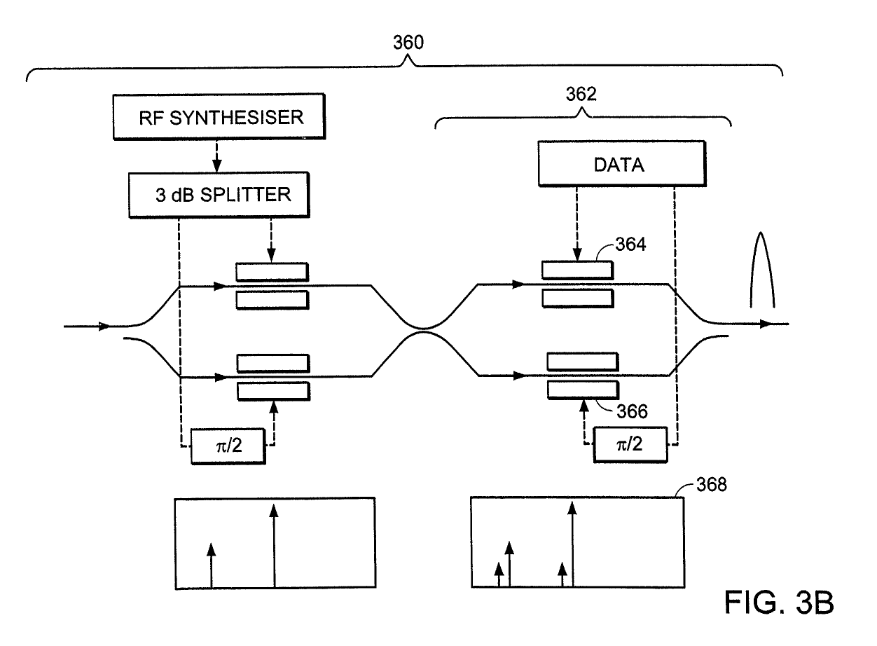

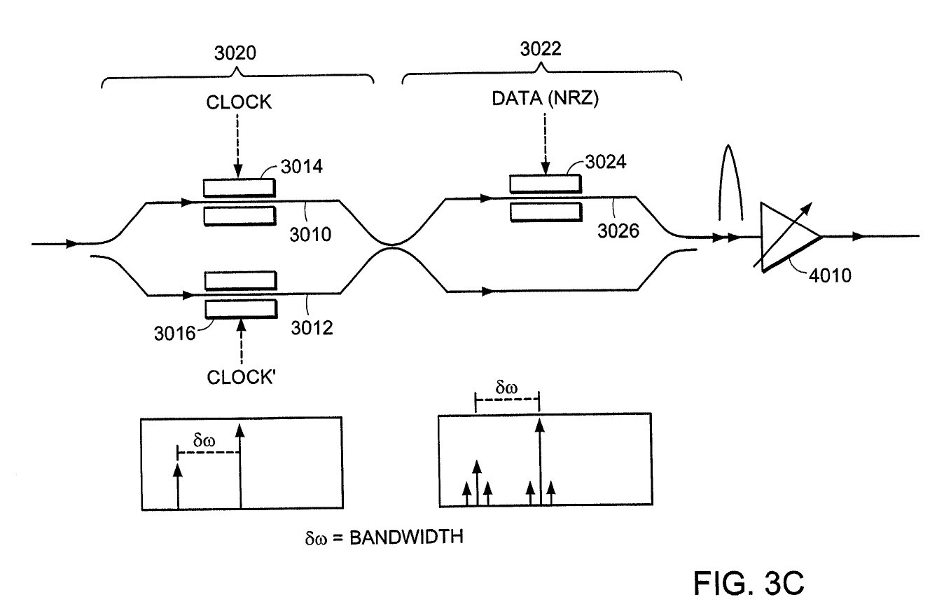

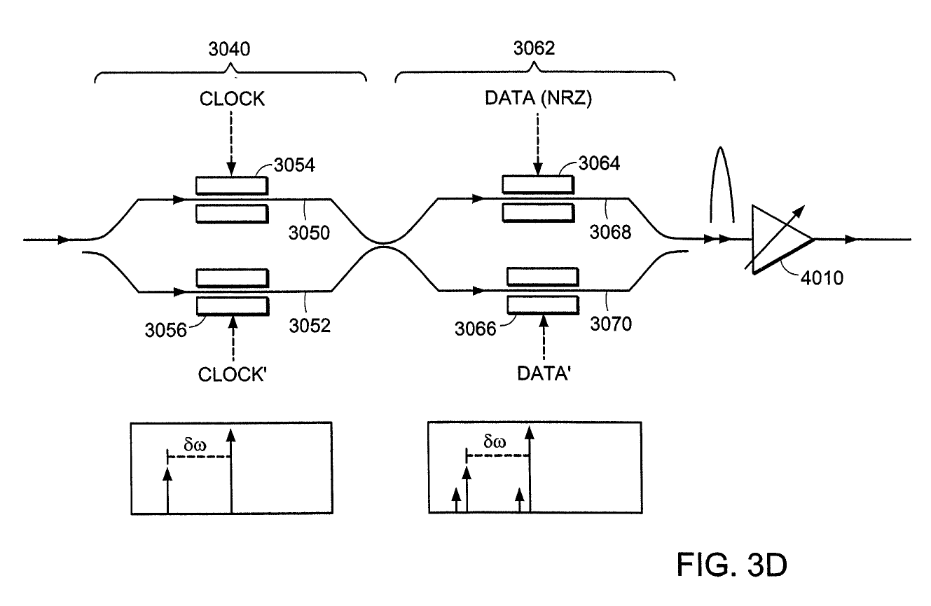

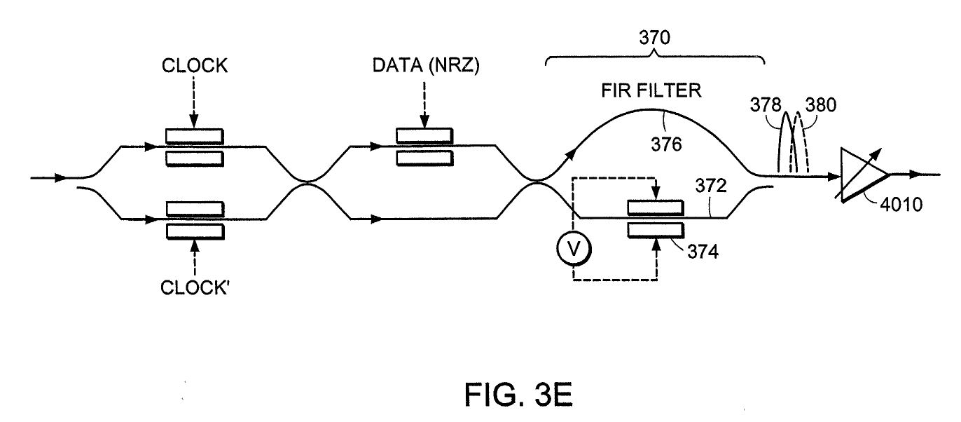

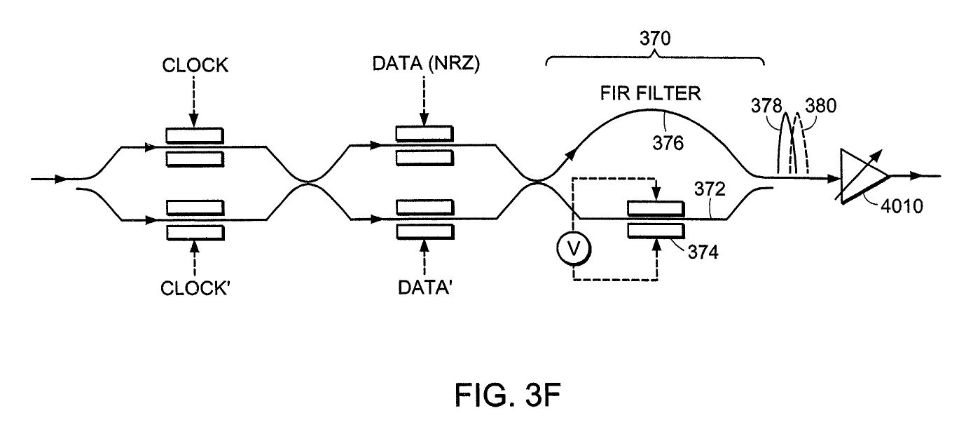

In one embodiment as shown in FIG. 3a, the light from a CW laser source is received by a transmission system 310 that may include a Mach-Zehnder type modulator/interferometer having some or all of the characteristics described in one or more of the patent applications incorporated by reference above. The modulator is a conventional RZ modulator except in a first stage 312 which has electrodes implanted on both legs 314, 316 respectively (instead of on only one leg). Both legs have respective electrodes 318, 320 implanted, which electrodes are driven by the same signal, from an RF synthesizer 322 through a splitter 324, with a phase difference of π/2, which causes production of an SSB optical signal which can be modulated with data in a second stage 326. In the second stage, an electrode 328 implanted on leg 330 is driven by a data signal source 332. As shown in spectral diagrams 340, 342 depicted below stages 312, 326 respectively, stage 312 produces an SSB signal that has an OC and an LSB and no RSB, and stage 326 adds data side bands 352, 354 around the LSB and data side bands 356, 358 around the OC.

FIG. 3c illustrates a general Hilbert transform case of which FIG. 3a is an example embodiment. In a first stage 3020, both legs 3010, 3012 have respective electrodes 3014, 3016 implanted, which electrodes are driven by a CLOCK signal and its Hilbert transform (CLOCK′ signal), respectively (the CLOCK and CLOCK′ signals have a phase difference of π/2). In a second stage 3022, an electrode 3024 implanted on leg 3026 is driven by an NRZ DATA signal. The CLOCK frequency and DATA modulation frequency are preferably equal.

In another embodiment as shown in FIG. 3b, modulator 360 is the same as or largely similar to the modulator of FIG. 3a except that the second stage 362 (data modulation section) also has respective electrodes 364, 366 implanted in both legs, which electrodes 364, 366 are driven by the same data signal with a phase difference of π/2. Accordingly, as shown in spectral diagram 368, a different final spectrum is produced in which side bands 354, 358 have been removed as compared to diagram 342 of FIG. 3a. FIG. 3d illustrates a general Hilbert transform case of which FIG. 3b is an example embodiment. In a first stage 3040, both legs 3050, 3052 have respective electrodes 3054, 3056 implanted, which electrodes are driven by a CLOCK signal and a CLOCK′ signal, respectively. In a second stage 3062, electrodes 3064, 3066 respectively implanted on legs 3068, 3070 are driven by an NRZ DATA signal and a DATA′ signal (the DATA and DATA′ signals have a phase difference of π/2), respectively.

In other embodiments as shown in FIGS. 3e, 3f, an FIR stage 370 including an FIR filter is added to the embodiments shown in FIGS. 3c, 3d respectively. In the embodiments of FIGS. 3e, 3f, stage 370 defines the spectral bands and reshape the optical signal. The FIR filter may have some or all of the characteristics described in one or more of the patent applications incorporated by reference above. In the FIR stage, only leg 372 has an electrode 374, and the phase difference between the two legs 372, 376 is set to produce the least errors, or nearly the least errors, experienced at the receiver. The optimum phase difference between the two legs may vary according to data rate and pulse duration. The delay in the FIR section is set such that the generated pulse is split into two overlapped pulses 378, 380 that are preferably one-half to one full FWHM (Full-Width Half-Maximum) apart.

### Soliton Creation

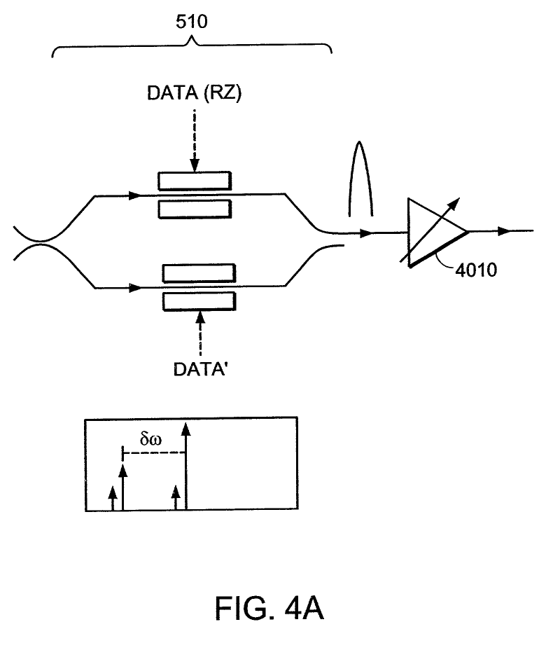

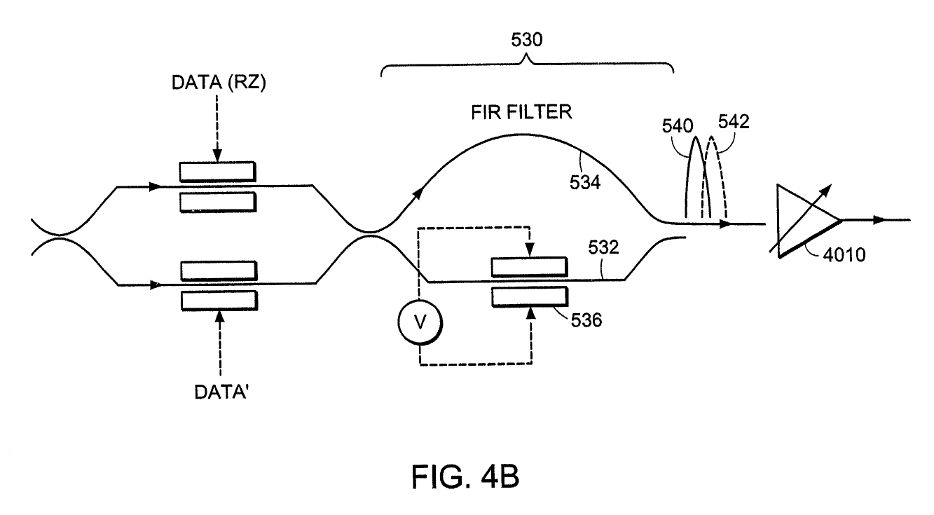

FIGS. 3c-3f, 4a-4b also show an amplitude adjuster 4010 which in one or more embodiments may include an optical amplifier and/or an optical attenuator and which may be used for optical signal amplitude adjustment, e.g., in soliton creation as described herein.

A pulse in optical fiber can take the form of a soliton pulse if the pulse has certain characteristics relative to the characteristics of the fiber, as explained in Agrawal, Govind P., Nonlinear Fiber Optics, 2^{nd} edition (Academic Press, Inc., New York, 1995), which describes the following relation (Agrawal at 145, equation 5.2.16):

P₀≈3.11|β₂|/γT_{FWHM}²

Where

P₀=pulse peak power

β₂=fiber second order chromatic dispersion coefficient

$$γ = \frac{{n}_{2} {ω}_{0}}{{cA}_{eff}}$$

T_{FWHM}=pulse duration

n₂=fiber nonlinear Kerr coefficient

ω₀=light angular frequency

A_{eff}=effective area of the fiber

C=light speed

As described above, an outgoing pulse stream having SSB spectral characteristics can be formed from an incoming pulse stream having DSB spectral characteristics, which pulse streams may or may not include soliton pulses. With an appropriate adjustment of peak through amplification, a soliton pulse stream (which may or may not contain data) having SSB spectral characteristics can be formed from the outgoing pulse stream. The adjustment, which can be performed automatically or manually, can be performed by, with, or within the apparatus described above, or can be performed by, with, or within other apparatus (e.g., apparatus that receives an SSB pulse stream produced as described above).

Solitons and the formation of solitons are further explained in Yariv, Optical Electronics in Modern Communications, 5^{th} edition (Oxford, 1997), particularly Chapter 19; Handbook Of Optics, Volume IV: Fiber Optics And Nonlinear Optics, 2^{nd} edition, edited by Michael Bass (McGraw-Hill, New York, 2001), particularly Chapter 7; and Hasegawa, Optical Solitons in Fibers for Communication Systems, Optics & Photonics News, February 2002.

### Variations

In connection with the above, the transmission technology may be modified in many ways. For example, the arrangements having IIR and/or FIR technology may employ different arrangements, such as tunable or passive IIR and/or FIR technology separately or in combination.

FIGS. 4a, 4b illustrate embodiments similar to the embodiments described above, but in which enhanced techniques used in connection with RZ methodology affect the spectral characteristics of the optical signal. In the embodiments of 4a, 4b, a data modulation stage is provided in which a modulator is driven with an electrical RZ data format pattern, which allows a clock modulation stage to be omitted in the generation of RZ SSB optical pulses. FIG. 4a shows a data RZ modulation stage 510 in which the legs are driven by a DATA signal and a DATA′ signal (the DATA and DATA′ signals have a phase difference of π/2), respectively.

FIG. 4b illustrates an embodiment in which an FIR filter stage 530 is added to the embodiment shown in FIG. 4a to further reshape the optical signal. The FIR filter stage may have some or all of the characteristics described in one or more of the patent applications incorporated by reference above. In the FIR filter stage, only leg 532 has an electrode 536, and the phase difference between the two legs 532, 534 is preferably set at π/2 (other phase differences, such as 0 or π, may be used). The delay in the FIR section is set such that the generated pulse is split into two overlapped pulses 540, 542 that are preferably one-half to one full FWHM apart.

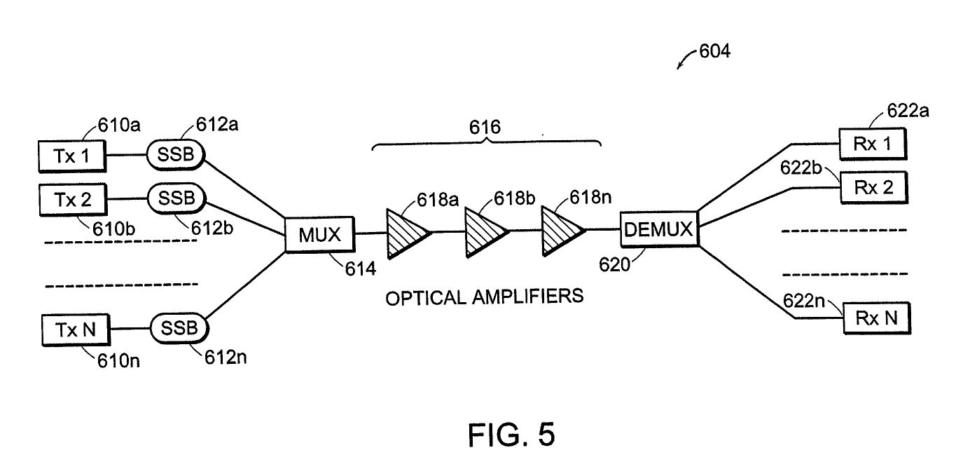

FIG. 5 illustrates an embodiment 604 in which at least a portion of one or more techniques described herein is used in a WDM application. Optical signals from transmitter devices 610a-610n are processed by systems 612a-612n, each of which systems may rely on at least a portion of one or more techniques described herein (e.g., techniques described in connection with embodiment 100 of FIG. 2 or system 310 of FIG. 3a). A WDM multiplexor device 614 receives the processed signals and directs a combined signal to link 616, which may include one or more optical amplifiers 618a-618n to propagate the combined signal to a WDM demultiplexor device 620 which reverses the combination process of device 614 and directs decombined signals to receiver devices 622a-622n corresponding to transmitter devices 610a-610n respectively.

WDM methodology is described in Iannone, Nonlinear Optical Communication Networks, John Wiley and Sons, New York, 1998.

The arrangements described above were illustrated with single filtering devices (e.g., filters) for the most part to avoid clutter. For example, the filters may be implemented as a cascaded arrangement of filters as well. Moreover, though not shown in the FIGS. to avoid clutter, gaining elements may be incorporated into the implementations, e.g., to compensate for any insertion loss from various components of the implementations. For example, the insertion loss of a device may be compensated by Erbium doped optical fiber amplifiers or the like, which may be placed before, after or within a filter block.

The transmission technology may use, in whole or in part, one or more of the filtration techniques described in one or more of the patent applications incorporated by reference above, e.g., for noise reduction or for another purpose.

It will be further appreciated that the scope of the present invention is not limited to the above-described embodiments, but rather is defined by the appended claims, and that these claims will encompass modifications of and improvements to what has been described.

What is claimed is:

1. An optical signal transmission apparatus, comprising:
an optical signal filter having a pass band spectral width and a center frequency configured such that the optical signal filter receives an input optical signal having double side band (DSB) spectral characteristics and produces an output optical signal having single side band (SSB) spectral characteristics;
wherein the optical signal transmission apparatus is configured to use the optical signal filter in the formation of a soliton optical signal having SSB spectral characteristics, the soliton optical signal including a soliton pulse wherein the peak power and the mid-amplitude width of the soliton pulse are linked by a relationship that depends on the characteristics of an optical medium in which the soliton pulse travels.

2. The apparatus of claim 1, wherein the optical signal filter includes an IIR filter.

3. The apparatus of claim 1, wherein the optical signal filter includes an FIR filter.

4. The apparatus of claim 1, wherein the input optical signal has spectral bands including an optical carrier (OC), a left side band (LSB), a right side band (RSB), and each of the side bands has corresponding left and right data side bands.

5. The apparatus of claim 1, further comprising:
a transmitter serving as at least an indirect source of the input optical signal, the configuration of the transmitter being responsive to the optical signal filter.

6. The apparatus of claim 1, further comprising:
a transmitter serving as at least an indirect source of the input optical signal, the configuration of the optical signal filter being responsive to the transmitter.

7. The apparatus of claim 1, wherein the output optical signal lacks a left side band (LSB) of the input optical signal.

8. The apparatus of claim 1, wherein the output optical signal lacks a right side band (RSB) of the input optical signal.

9. The apparatus of claim 1, wherein the output optical signal lacks a data side band of the input optical signal.

10. The apparatus of claim 1, wherein the output optical signal lacks a side band of the input optical signal and lacks a data side band of the input optical signal.

11. The apparatus of claim 1, wherein the output optical signal lacks multiple side bands of the input optical signal.

12. An optical signal transmission apparatus, comprising:
a first modulator configured to form a modulated RZ optical signal from an input optical signal, the modulated RZ optical signal having single side band (SSB) spectral characteristics; and
a signal generator having a second modulator, the signal generator being configured to use the second modulator to form a data modulated optical signal from the modulated RZ optical signal;
wherein the optical signal transmission apparatus is configured to use the first modulator and the signal generator in the formation of a soliton optical signal that has SSB spectral characteristics, the soliton optical signal including a soliton pulse wherein the peak power and the mid-amplitude width of the soliton pulse are linked by a relationship that depends on the characteristics of an optical medium in which the soliton pulse travels.

13. The apparatus of claim 12, wherein the modulated RZ optical signal lacks a side band of the input optical signal.

14. The apparatus of claim 12, wherein the first modulator includes at least a portion of a Mach-Zehnder type modulator/interferometer.

15. The apparatus of claim 12, wherein the second modulator includes at least a portion of a Mach-Zehnder type modulator/interferometer.

16. The apparatus of claim 12, wherein the first modulator has first and second legs driven by the same signal with a phase difference of π/2.

17. The apparatus of claim 12, wherein the second modulator has first and second legs driven by the same signal with a phase difference of π/2.

18. The apparatus of claim 12, wherein the modulated RZ optical signal includes an SSB signal that lacks a data side band of the input optical signal.

19. The apparatus of claim 12, further comprising:
an impulse response filter in communication with the second modulator.

20. The apparatus of claim 12, further comprising:
an impulse response filter in communication with the second modulator, the impulse response filter having first and second legs driven by the same signal with a phase difference of π/2.

21. The apparatus of claim 12, further comprising:
an impulse response filter in communication with the second modulator, the impulse response filter producing two overlapped pulses that are one-half to one full FWHM apart.

22. An optical signal transmission apparatus, comprising:
optical signal processing apparatus configured to form an optical signal having single side band (SSB) spectral characteristics, the optical signal including a soliton pulse.

23. The apparatus of claim 22, wherein the optical signal includes a dispersion managed soliton pulse.

24. The apparatus of claim 23, wherein the optical signal includes an output optical signal that is derived from an input optical signal, and the output optical signal lacks a side band of the input optical signal.

25. An optical signal transmission apparatus, comprising:
a wavelength division multiplexing system having an optical signal filter having a pass band spectral width and a center frequency configured such that the optical signal filter receives an input optical signal having double side band (DSB) spectral characteristics and produces an output optical signal having single side band (SSB) spectral characteristics;
wherein the optical signal transmission apparatus is configured to use the optical signal filter in the formation of a soliton optical signal having SSB spectral characteristics, the soliton optical signal including a soliton pulse wherein the peak power and the mid-amplitude width of the soliton pulse are linked by a relationship that depends on the characteristics of an optical medium in which the soliton pulse travels.

26. An optical signal transmission apparatus, comprising:
a wavelength division multiplexing system having:
a first modulator configured to form a modulated RZ optical signal from an input optical signal, the modulated RZ optical signal having single side band (SSB) spectral characteristics; and
a signal generator having a second modulator, the signal generator being configured to use the second modulator to form a data modulated optical signal from the modulated RZ optical signal;
wherein the optical signal transmission apparatus is configured to use the first modulator and the signal generator in the formation of a soliton optical signal that has SSB spectral characteristics, the soliton optical signal including a soliton pulse wherein the peak power and the mid-amplitude width of the soliton pulse are linked by a relationship that depends on the characteristics of an optical medium in which the soliton pulse travels.

27. A method for use in optical signal transmission, comprising:
receiving an input optical signal having double side band (DSB) spectral characteristics;
optically filtering the input optical signal to produce an output optical signal having single side band (SSB) spectral characteristics; and
causing the output optical signal to include a soliton pulse wherein the peak power and the mid-amplitude width of the soliton pulse are linked by a relationship that depends on the characteristics of an optical medium in which the soliton pulse travels.

28. The method of claim 27, further comprising
using an IIR filter to optically filter the input optical signal.

29. The method of claim 27, further comprising
using an FIR filter to optically filter the input optical signal.

30. The method of claim 27, wherein the input optical signal has spectral bands including an optical carrier (OC), a left side band (LSB), a right side band (RSB), and each of the side bands has corresponding left and right data side bands.

31. The method of claim 27, further comprising:
using a transmitter as at least an indirect source of the input optical signal, the configuration of the transmitter being responsive to the optical filtering.

32. The method of claim 27, further comprising:
using a transmitter as at least an indirect source of the input optical signal, the configuration of the optical filtering being responsive to the transmitter.

33. The method of claim 27, wherein the output optical signal lacks a left side band (LSB) of the input optical signal.

34. The method of claim 27, wherein the output optical signal lacks a right side band (RSB) of the input optical signal.

35. The method of claim 27, wherein the output optical signal lacks a data side band of the input optical signal.

36. The method of claim 27, wherein the output optical signal lacks a side band of the input optical signal and lacks a data side band of the input optical signal.

37. The method of claim 27, wherein the output optical signal lacks multiple side bands of the input optical signal.

38. A method for use in optical signal transmission, comprising:
forming a modulated RZ optical signal from an input optical signal, the modulated RZ optical signal having single side band (SSB) spectral characteristics; and
forming a data modulated optical signal from the modulated RZ optical signal;
wherein the data modulated optical signal includes a soliton optical signal that has SSB spectral characteristics, the soliton optical signal including a soliton pulse wherein the peak power and the mid-amplitude width of the soliton pulse are linked by a relationship that depends on the characteristics of an optical medium in which the soliton pulse travels.

39. The method of claim 38, wherein the modulated RZ optical signal lacks a side band of the input optical signal.

40. The method of claim 38, furthering comprising
using at least a portion of a Mach-Zehnder type modulator/interferometer to form the modulated RZ optical signal.

41. The method of claim 38, furthering comprising
using at least a portion of a Mach-Zehnder type modulator/interferometer to form the data modulated optical signal.

42. The method of claim 38, furthering comprising
in the formation of the modulated RZ optical signal, using a modulator having first and second legs wherein the second leg is driven by a phase offset version of the same signal that drives the first leg.

43. The method of claim 38, furthering comprising
in the formation of the data modulated optical signal, using a modulator having first and second legs wherein the second leg is driven by a phase offset version of the same signal that drives the first leg.

44. The method of claim 38, wherein the modulated RZ optical signal includes an SSB signal that lacks a data side band of the input optical signal.

45. The method of claim 38, furthering comprising
causing the soliton optical signal to include overlapped pulses that are one-half to one full FWHM apart.
